(19) United States
(12) Patent Application Publication
(10) Pub. No.: US 2008/0236344 A1
(43) Pub. Date: Oct. 2, 2008

(54) MULTIPURPOSE SELF-ADJUSTING LOCKING PLIERS AND CLAW HAMMER COMBINATION

(76) Inventor: Wen-yueh Chiang, Wufeng (TW)

Correspondence Address: SAM CHEN, 7F-1, 293, ROOSEVELT ROAD, SEC 3, TAIPEI, TW

(21) Appl. No.: 11/691,493

(22) Filed: Mar. 26, 2007

(51) Int. Cl. B25B 7/12

(52) U.S. Cl. 81/368

(57) ABSTRACT

A multipurpose self-adjusting locking pliers and claw hammer combination is disclosed that includes a self-adjusting locking pliers unit including an upper jaw, a pivotal lower jaw, a stationary handle having a rear adjustment member, and a pivotal trigger handle having a release lever; and a hammer unit including a head downwardly projecting from the lower jaw and a claw upwardly rearward projecting from the upper jaw.

### BACKGROUND OF THE INVENTION

1. Field of Invention

The invention relates to pliers and more particularly to the head of a multipurpose self-adjusting locking pliers integrally formed with both the downwardly projecting head of a claw hammer and the upwardly rearward projecting claw thereof.

2. Description of Related Art

Multipurpose tools are popular among construction workers especially those working in a high rise building. This is because a construction worker involved in such kind of work desires to reduce the weight of tool(s) he/she carries. Ideally, a construction worker desires to carries only one tool (e.g., multipurpose tool) for working.

Multipurpose self-adjusting locking pliers are well known devices. Also, claw hammers are well known devices. However, so far as the inventor is aware, a type of multipurpose self-adjusting locking pliers and claw hammer combination has not been commercially available.

Still, there have been numerous suggestions in prior patents for self-adjusting locking pliers. For example, U.S. Pat. No. 7,134,365 discloses a self-adjusting locking pliers. Thus, continuing improvements in the exploitation of multipurpose self-adjusting locking pliers are constantly being sought.

### SUMMARY OF THE INVENTION

It is therefore one object of the invention to provide a pair of multipurpose self-adjusting locking pliers having its head integrally formed with both the downwardly projecting head of a claw hammer and the upwardly rearward projecting claw thereof such that the functions of a claw hammer are additionally incorporated thereinto.

The above and other objects, features and advantages of the invention will become apparent from the following detailed description taken with the accompanying drawings.

### BRIEF DESCRIPTION OF THE DRAWINGS

FIG. 1 is a side elevation of a multipurpose self-adjusting locking pliers and claw hammer combination according to the invention;

FIG. 1A is a sectional view taken along line A-A of FIG. 1;

FIG. 1B is a perspective view taken from the direction B of FIG. 1;

FIG. 1C is a perspective view taken from the direction C of FIG. 1;

FIG. 1D is a perspective view taken from the direction D of FIG. 1;

FIG. 2 is an environmental view of the invention in which the claw is operated for extracting a nail from wood; and

FIG. 3 is another environmental view of the invention in which the hammer head is operated for pounding an object.

### DETAILED DESCRIPTION OF THE INVENTION

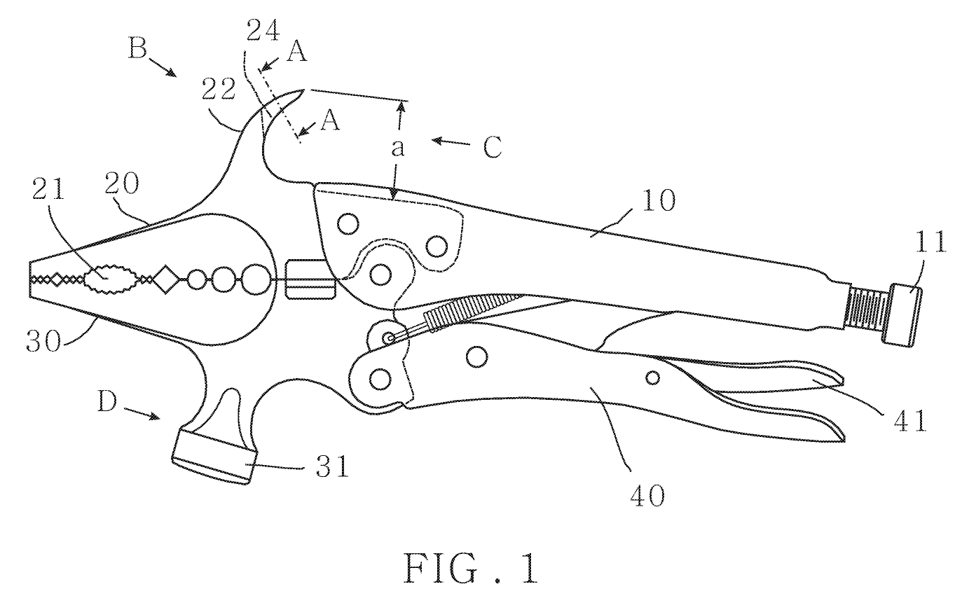

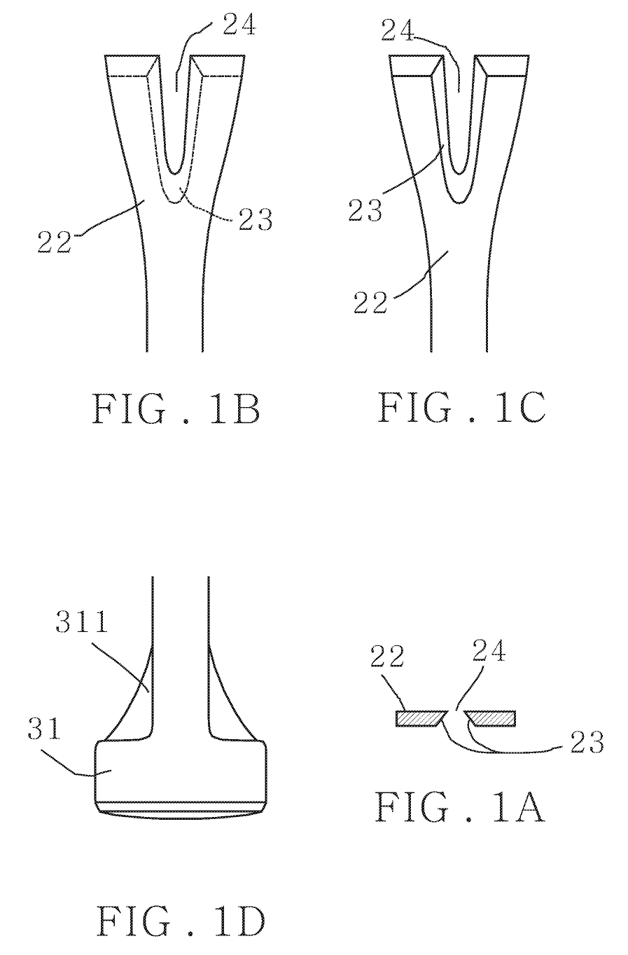

Referring to FIGS. 1 to 1D, a multipurpose self-adjusting locking pliers and claw hammer combination in accordance with a preferred embodiment of the invention is shown and comprises the following components.

An upper jaw 20 and a lower jaw 30 are provided. The lower jaw 30 is adapted to close onto the upper jaw 20 to form an aperture 21 therebetween. Each of the jaws 20 and 30 has a serrated gripping surface extending from about its midpoint to its open end including edge of the aperture 21. The jaws 20 and 30 are adapted to grip, twist, and pull wires. A pronged claw 22 projects upwardly rearward from the upper jaw 20. The claw 22 has a V-shaped fork 24 having two inclined surfaces 23 on both sides being joined at a valley of the fork 24. Moreover, the lower jaw 30 has a downward projecting head 31 served a hammer head. The head 31 has two opposite braces 311 on both sides.

An elongate stationary handle 10 extends rearward from the upper jaw 20. A distance from a top of a rear portion of the upper jaw 20 to tips of the fork 24 is “a”. An upper rear portion of the lower jaw 30 is pivotably secured to the stationary handle 10. The stationary handle 10 has a thumb screw 11 threadedly secured to a rear end. The thumb screw 11 serves as a means for fine adjustment of the jaw 20 such that an object being gripped by the jaws 20 and 30 can be locked.

A trigger handle 40 is pivotably secured to a rear portion of the lower jaw 30. The trigger handle 40 has an upper release lever 41 pivotably fastened therein.

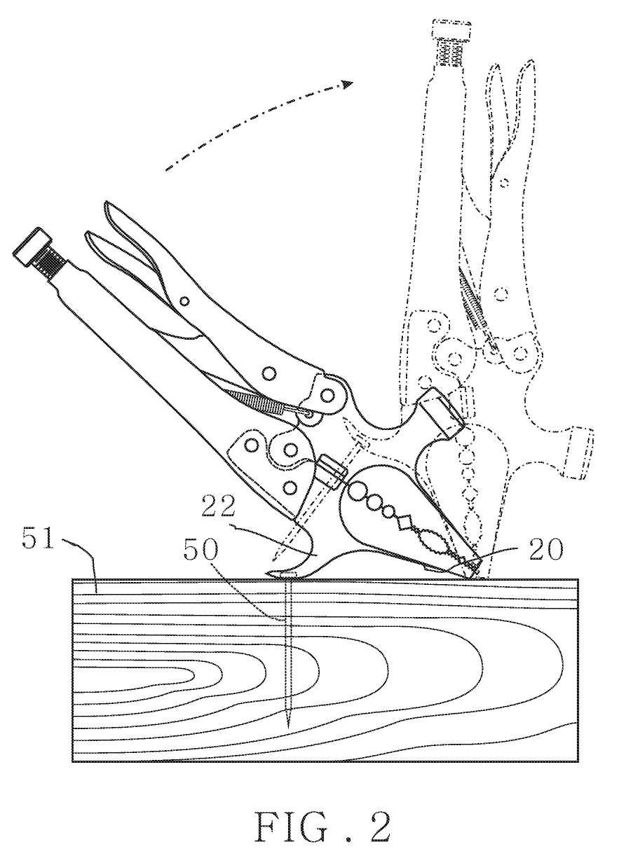

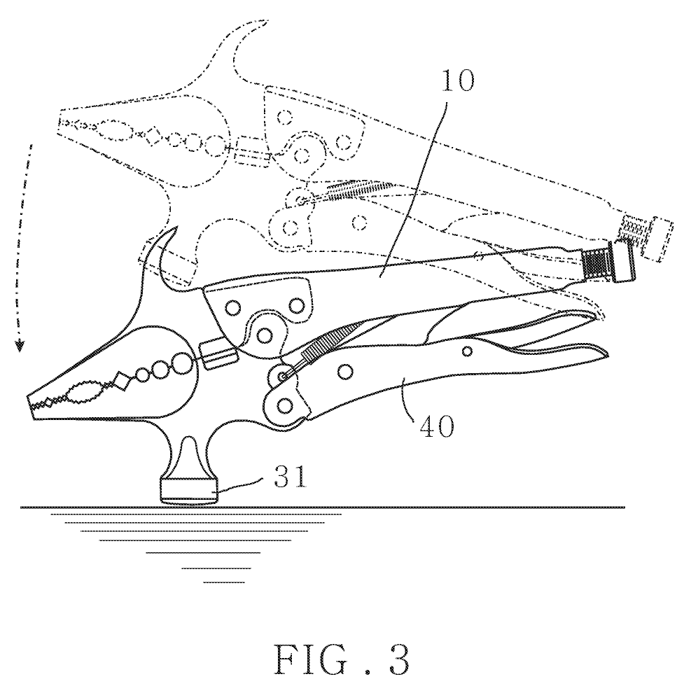

Referring to FIG. 2, a first operation of the invention will be described in detailed below. The claw 22 is pivoted clockwise as indicated by arrow to extract a nail 50 from wood 51 by utilizing the upper jaw 20 as a fulcrum urged against the wood 51.

Referring to FIG. 3, a second operation of the invention will be described in detailed below. A hand (not shown) holds the handles 10 and 40 to pound an object using the head 31 as indicated by arrow.

While the invention herein disclosed has been described by means of specific embodiments, numerous modifications and variations could be made thereto by those skilled in the art without departing from the scope and spirit of the invention set forth in the claims.

What is claimed is:

1. A tool comprising:
a self-adjusting locking pliers unit including an upper jaw, a lower jaw, a stationary handle having a rear adjustment member, a trigger handle having a release lever, a first pivot for pivotably securing the lower jaw to the stationary handle, and a second pivot for pivotably securing the trigger handle to the lower jaw; and
a hammer unit including a head downwardly projecting from the lower jaw and a claw upwardly rearward projecting from the upper jaw.
